(19) United States
(12) Patent Application Publication
(10) Pub. No.: US 2010/0013164 A1
(43) Pub. Date: Jan. 21, 2010

(54) SEALING SYSTEM FOR SEALING OFF A PROCESS GAS SPACE WITH RESPECT TO A LEAKTIGHT SPACE

(76) Inventor: Franz-Josef Meyer, Emmerich (DE)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 11/918,301

(22) PCT Filed: Apr. 10, 2006
(86) PCT No.: PCT/EP2006/061467

§ 371 Date: Sep. 29, 2009

(30) Foreign Application Priority Data
Apr. 14, 2005 (EP) 05008206.4

(51) Int. Cl. F16J 15/447; F04D 29/10

(52) U.S. Cl. 277/303; 277/412; 415/230

(57) ABSTRACT

Gas seals are embodied in the form of contactless joints for sealing a gas processing chamber with respect to a sealed chamber, wherein a gas leak is generally extremely low. A locking labyrinth comprising at least one chamber to which the gas is supplied and which is placed upstream of the gas seal makes it possible to avoid said situation. The chamber is provided with a rate control element for operating with a constant supply pressure and for supplying the chamber with a predetermined rate gas flow.

### CROSS REFERENCE TO RELATED APPLICATIONS

This application is the US National Stage of International Application No. PCT/EP2006/061467, filed Apr. 10, 2006 and claims the benefit thereof. The International Application claims the benefits of European application No. 05008206.4 filed Apr. 14, 2005, both of the applications are incorporated by reference herein in their entirety.

### FIELD OF INVENTION

The invention relates to a locking labyrinth to be acted upon with a gas and to be arranged upstream of a gas seal, with at least one chamber, and to a gas sealing system with a gas seal and with a locking labyrinth being arranged upstream of the gas seal. The invention leads on to a housing and a compressor. The invention relates, further, to a method for sealing off a process gas space with respect to a leaktight space, with a gas sealing system having a gas seal and a locking labyrinth arranged upstream of the gas seal on the process gas side and having at least one chamber.

### BACKGROUND OF THE INVENTION

Gas seals are contactless seals with extremely low leakages. They are suitable particularly for sealing off rotating parts, such as, for example, a shaft. In this context, “contactless” means that, although the gas seal can be pressed down via a spring when the otherwise moved part (for example, the shaft) is at a standstill, nevertheless, during operation, the gas seal normally lifts off on account of the movement of the part. Such gas seals are increasingly employed for sealing off turbocompressors. Where a compressor is concerned, a gas seal may be employed, for example, for sealing off a rotating shaft. When the shaft is in operation, for example at a rotational speed above 3000 revolutions per minute, the gas seal lifts off from the shaft and forms a gap with respect to the shaft, said gap normally lying in the micrometer range.

In very general terms, a gas seal serves for sealing off a process gas space with respect to a leaktight space and, in principle, could be arranged directly adjacently to the process gas space, to be precise for the straightforward situation where a process gas can be in direct contact with the gas seal.

However, there are process gases which should not reach the gas seal, since they would damage this, for example by corrosion, polymerization or similar chemical, mechanical or other adverse processes. Whereas, in principle, process gas may be understood as meaning any desired process gas, the problem referred to arises particularly in the case of chemically highly reactive process gases, such as, for example, chlorine gas. Such and other gases possibly harmful to gas seals may occur particularly in compressors, for example in the power station sector or in the offshore oil or natural gas sector.

In such difficult situations, when gas seals are used, a locking labyrinth is locked by means of a gas on the process gas side upstream of the gas seal, so that process gas is kept away from the gas seal. In the event that external locking gas is used, external locking gas passes into the process gas via the locking labyrinth, this being a disadvantage. Sometimes, purified process gas, that is to say pure gas, is provided as locking gas in the prior art. However, this measure serves particularly for repelling dirt in respect of the gas seal and is complicated.

If no external locking gas should enter the process gas, which is often the case, for example, in chlorine compressors, what is known as a multichamber locking labyrinth with differential pressure regulation is employed in the prior art. Such a multichamber locking labyrinth is described particularly in the detailed description referring to FIG. 1. The disadvantage of this is that, even in the case of sealing off under atmospheric pressure, relatively large quantities of locking gas are required and, likewise, large quantities of process gas are lost. On account of differential pressure regulation, at higher sealing-off pressures and depending on the disposal pressure, which may sometimes be around 2 bar, 3 bar or above, either the process gas loss or the locking gas requirement also rises considerably.

Known locking labyrinths therefore have relatively high leakages because of the conventional differential pressure regulation, even at somewhat low sealing-off pressures and/or disposal pressures.

It would be desirable to have comparatively low gas leakages and to keep process gas away from a gas seal.

### SUMMARY OF INVENTION

This is where the invention comes in, the object of which is to specify a device and a method which are used for sealing off a process gas space with respect to a leaktight space and in which process gas can be kept away from a gas seal, gas leakages being kept as low as possible.

In terms of the device, the object is achieved by the invention by means of a locking labyrinth of the type initially mentioned in which, according to the invention, the inlet has a quantity control element which is designed for operation at a constant admission pressure and for acting upon a chamber with a gas flow at a predetermined throughput rate.

The invention in this case proceeds from the consideration that a locking labyrinth can advantageously be designed such that as low pressures as possible arise. In this respect, the invention has recognized that what is the most suitable for this purpose is a quantity control element which is designed for operating at a constant admission pressure for acting upon a chamber with a gas flow at a predetermined, that is to say stipulated throughput rate. In other words: a locking gas is fed into the chamber at a constant admission pressure in a quantity such that, in the locking labyrinth, a predetermined flow velocity occurs which is sufficient for reliably locking the gas seal against process gas by means of the locking labyrinth. In this case, it was shown, surprisingly, that an extremely low differential pressure with respect to the chamber can be implemented in the locking labyrinth, thus leading to a comparatively low gas leakage, as compared with conventional locking labyrinths.

In terms of the device, the object is also achieved by the invention by means of a gas sealing system with a gas seal and with a locking labyrinth, the locking labyrinth being arranged upstream of the gas seal, and, according to the invention, an inlet chamber of the locking labyrinth being arranged directly adjacently to the gas seal, and the gas seal and the locking labyrinth being designed in such a way that the gas seal has a negligibly low gas leakage, as compared with the locking labyrinth.

In other words: the locking labyrinth is arranged adjacently to the gas seal in such a way that a locking gas stream solely leads away from the gas seal in order to protect the latter. In particular, in this case, the situation is avoided where a locking gas stream leads from the locking labyrinth into a space, not belonging to the locking labyrinth, between the gas seal and locking labyrinth. In addition, the gas seal has a gas leakage which is lower by a multiple than the locking labyrinth. To be precise, the result of these two measures is that a gas leakage from a locking labyrinth which is directed toward the gas seal is virtually negligible. On this basis, a predetermined throughput rate for a locking gas can be set by means of a comparatively simply designed quantity control element, for example at the inlet of a chamber. Since virtually no relevant gas leakages occur toward the gas seal, such a locking labyrinth can be implemented with extremely low differential pressures, so that, overall, a gas leakage from the locking labyrinth is lower by a multiple than that in conventional locking labyrinths.

Preferred developments of the invention may be gathered from the subclaims and specify in particular advantageous possibilities for implementing the general concept of the invention.

In particular, with regard to the locking labyrinth, a chamber is designed so as to be free of a differential pressure regulator. As was recognized by the invention, when differential pressure regulators are used, the situation cannot be ruled out where excessively high differential pressures with respect to a chamber of the locking labyrinth occur, thus resulting in rising gas leakages. This is avoided, according to the concept of the invention, by the alternative use of a quantity control element.

In particular, a gas seal-side chamber of the locking labyrinth is outlet-free with the exception of one or more gas passages to a space or to a further chamber of the locking labyrinth. In particular, a gas seal-side chamber toward the gas seal is outlet-free. A gas passage is to be understood within the meaning of the present application as meaning, in particular, a gap or another passage directly on the moved part, for example the shaft, that is to say a passage or gap which is sufficient only for a gas leakage and which occurs due to an initially explained lift-off of the gas sealing system. In contrast to this, an inlet or an outlet for a chamber is to be understood as meaning a feed or disposal port provided according to the concept for a gas. The further space may be, for example, a process gas space or another space which is further away from the gas seal than the gas seal-side chamber. It is advantageous, in other words a locking labyrinth is designed such, that the gas seal-side chamber is always a feed chamber, so that a gas stream directly adjacent to the gas seal points away from the gas seal.

In the present case, a gas stream may be understood as meaning, above all, a locking gas stream, for example a gas stream using atmospheric gas or nitrogen. Such a gas stream may be supplied or discharged through a vent, as it is known, or ventilation. Under certain circumstances, what is also suitable as a gas stream is a process gas stream, insofar as this does not come into direct contact with the gas seal. In particular, it may be purified process gas, that is to say pure gas. A process gas stream used in a locking labyrinth makes sense particularly within the framework of a multichamber locking labyrinth which is explained in detail below.

A process gas stream is advantageously to be disposed of from a chamber of the locking labyrinth via a disposal, for example a flare, a water bath, a filter or another purification system.

The preferred developments mentioned above can be executed, in particular, such that a differential pressure between a chamber and a further space and/or between two communicating chambers of a multichamber locking labyrinth lies below 100 mbar, in particular below 50 mbar.

This may be achieved particularly advantageously in that, according to a development of the gas sealing system, the gas leakage of the gas seal is set lower by at least a power of ten than the gas leakage of the locking labyrinth.

The predetermined throughput rate, and consequently the predetermined flow velocity and advantageously also said differential pressure which is particularly low according to the concept, can be set particularly advantageously via a quantity control element in the form of a diaphragm. A quantity control element which is regulatable is particularly preferable. Thus, the quantity control element can not only be set to the dimensioning of a locking labyrinth and/or of a gas sealing system, but can be readjusted, as required, for example in the case of transient operating profiles.

A multichamber locking labyrinth is not only suitable for keeping process gas away from a gas seal, but, furthermore, also for keeping locking gas away from the process gas space.

As regards a multichamber locking labyrinth, it has proved particularly advantageous, within the framework of a development, for the locking labyrinth to have at least two communicating chambers, a first of the at least two chambers having an inlet and a second of the at least two chambers having an outlet, and the at least two communicating chambers being connected via at least one gas passage. Within the framework of the development of the proposed concept, there is advantageously provision for the inlet and/or the outlet to have a quantity control element which is designed for operation at a constant admission pressure and for acting upon a chamber with a gas flow at a predetermined throughput rate. A quantity control element may therefore be arranged, as required, in the case of one or more chambers, at the inlet and/or at the outlet.

In a particularly preferred development of the invention, the locking labyrinth is formed by exactly three communicating chambers, a first and a third of the three chambers having an inlet and a second of the three chambers having an outlet and the three communicating chambers being connected via at least one gas passage. Such a three-chamber locking labyrinth is advantageously designed for being acted upon with gas streams of a different type.

According to a preferred design of this development, the second chamber is arranged between the first and the third chamber, and a first gas passage is formed between the first and the second chamber and a second gas passage is formed between the third and the second chamber. According to the preferred design, the first and the second gas passage are designed for opposite gas flows. This preferred design is particularly suitable for acting upon the first chamber with a locking gas and for acting upon the third chamber with a process gas. To be precise, by the first chamber being acted upon with locking gas (for example, nitrogen), process gas is thereby kept away from the gas seal. On the other hand, acting upon the third chamber with process gas prevents locking gas from entering the process gas space. Instead, both the locking gas and the process gas are discharged via the middle second chamber. The locking gas/process gas mixture thereby formed in the second chamber can be quantity-regulated, for example, via a quantity control element in the form of a diaphragm, at the outlet of the second chamber so that a predetermined flow velocity sufficient for locking is formed in the locking labyrinth. Such a flow velocity is set, in particular, in a gas passage between the chambers. In this case, according to the concept, it is possible that differential pressures between the first and the second chamber or between the third and the second chamber lie only in the range between 10 mbar and 50 mbar.

The invention also leads on, in terms of the device, to a housing with a sealing system of the type explained above, according to the concept the sealing system being arranged between a process gas space and a leaktight space. The housing is advantageously arranged around a shaft, the sealing system being of annular design. In particular, a compressor provided with such a housing proves to be advantageous, as compared with conventional compressors.

As regards the method, the object is achieved by the invention by means of a method of the type initially mentioned, in which, according to the invention,
an inlet chamber, arranged directly adjacently to the gas seal, of the locking labyrinth is acted upon with gas;
a gas leakage of the gas seal is kept negligibly low, as compared with a gas leakage of the locking labyrinth; and
a chamber is acted upon with a constant admission pressure and with a gas flow at a predetermined throughput rate, the gas flow, in particular at the inlet, being quantity-regulated.

The advantages explained in connection with the device are implemented according to the novel concept by means of the method.

In particular, by the inlet chamber of the locking labyrinth being arranged directly adjacently to the gas seal and because the gas leakage of the gas seal is kept negligibly low, a gas loss through the gas seal itself or toward the gas seal is virtually negligible, as compared with conventional methods. It is thus possible according to the novel concept, within the framework of the method, to act upon a chamber with a constant admission pressure and with a gas flow at a predetermined throughput rate, the gas flow at the inlet being quantity-regulated. It is most particularly advantageous in this case that differential pressure regulation may be dispensed with within the framework of the novel concept.

### BRIEF DESCRIPTION OF THE DRAWINGS

Exemplary embodiments are described below by means of the drawing, in comparison with the prior art which is likewise illustrated. The drawing is not intended to illustrate the exemplary embodiments true to scale, but, instead, the drawing is executed, where it is expedient for an explanation, in diagrammatic and/or slightly distorted form. With regard to additions to the teachings which can be recognized directly from the drawing, reference is made to the relevant prior art. In particular, in the drawing:

FIG. 1 shows a multichamber locking labyrinth with differential pressure regulation according to the prior art, in which, moreover, a gas leakage toward the gas seal is provided, this leading to comparatively high differential pressures between the chambers and to correspondingly high gas leakages;

FIG. 2 shows a particularly preferred embodiment of a sealing system according to the novel concept with a three-chamber locking labyrinth and with a double gas seal;

FIG. 3 shows a further particularly preferred embodiment of a sealing system according to the novel concept with a three-chamber locking labyrinth and with a tandem gas seal without an internal labyrinth;

FIG. 4 also shows a further particularly preferred embodiment of a sealing system according to the novel concept with a three-chamber locking labyrinth and with a tandem gas seal with an internal labyrinth.

### DETAILED DESCRIPTION OF INVENTION

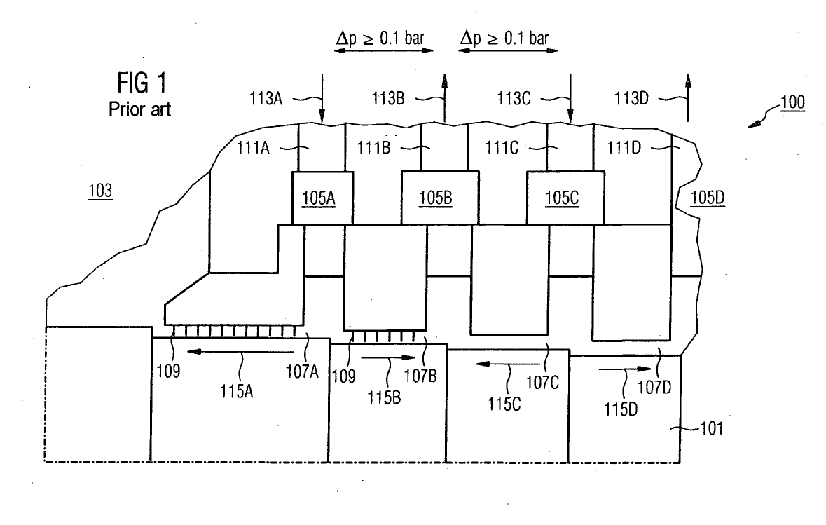

FIG. 1 shows a locking labyrinth 100 according to the prior art, which is part of a sealing system, not illustrated in any more detail, in a housing of a compressor. The sealing system, like the locking labyrinth 100, is arranged annularly around a shaft 101 and in this case seals off a process gas space 103 with respect to a leaktight space, not illustrated in any more detail. In the present case, the locking labyrinth 100 is formed with four chambers 105A, 105B, 105C, 105D. The chambers 105A, 105B, 105C, 105D are in each case connected as communicating chambers to a gas passage 107A, 107B, 107C, 107D. A gas passage 107A, 107B, 107C, 107D is diagrammatically illustrated, exaggerated, in FIG. 1. In actual fact, a gas passage 107A, 107B, 107C, 107D in the form of as small a gap as possible between the locking labyrinth 100 and the shaft 101 is formed. In order further to lower a gas leakage through a gas passage, in the present case the gas passage 107A and 107B is additionally provided with sealing lamellae 109. In contrast to the gas passages 107A, 107B, 107C, 107D, designed solely for gas leakage, the multichamber locking labyrinth has four ports 111A, 111B, 111C, 111D, not illustrated in any more detail. In the case of the chamber 105A and 105C, these are formed in the form of an inlet for a gas flow 113A, 113C. The gas flow 113A is in the form of a process gas stream. The gas flow 113C is in the form of a locking gas stream. The chambers 105B, 105D are provided with an outlet 111B, 111D, not illustrated in any more detail, which is provided in each case for the emergence of a gas stream 113B, 113D. The gas stream 113B is in the form of a process gas/locking gas mixture which is supplied via the outlet 111B to the external surroundings for disposal, for example a flare, a water bath, a filter device or another purification device. The gas stream 113B is in the form of a locking gas stream, for example a nitrogen oxide stream, which, as a rule, is not to be purified any further, and can be discharged via conventional ventilation (“vent”). The multichamber locking labyrinth 100 according to the prior art ensures not only that process gas is as far as possible kept away from a gas seal, to be arranged further to the right and not illustrated in any more detail, but, furthermore, also that no external locking gas from the locking gas stream 113C enters the process gas in the process gas space 103.

Such a multichamber locking labyrinth is often suitable in chlorine compressors. Locking gas is delivered to a chamber 105C via a gas stream 113C and is supplied via gas passages 107C, 107D in the form of a corresponding locking gas leakage stream 115C, 115D to the communicating chambers 105B and 105D lying next to them. The locking gas leakage stream 115D from the chamber 105C to the chamber 105D ensures essentially that a gas seal, not illustrated in more detail, comes into contact only with harmless locking gas, for example nitrogen. The locking gas leakage stream 115C in the gas passage 107C to the chamber 105B is opposite to a process gas leakage stream 115B from the chamber 105A to the chamber 105B. The chamber 105C and 105D is thereby locked as far as possible with respect to process gas from the gas stream 113A and 113B. Instead, the process gas supplied via the gas stream 113A to the chamber 105A, together with the harmless locking gas of the gas stream 113C and of the locking gas leakage stream 107C, is supplied through the chamber 105B and the corresponding outlet 111B in the form of a gas stream 113B with a locking gas/process gas mixture to a disposal, not illustrated in any more detail. The further process gas leakage stream 115A, brought about by the gas stream 113A in the form of a process gas stream, in the gas passage 115A between the chamber 105A and the process gas space 103 ensures that the multichamber locking labyrinth 100 is locked as far as possible against process gas from the process gas space 103.

Since, in the present case, process gas is used in the gas stream 113A, this as far as possible ensures that only process gas in the form of the process gas leakage stream 115A is supplied to the process gas space 103 via the process gas leakage passage 107A.

Moreover, an intermixing of process gas and locking gas in the process gas space 103 is counteracted by the process gas leakage stream 115B, since the latter is directed opposite to the locking gas leakage stream 115C.

The size of the leakage streams 115A, 115B, 115C, 115D in the gas passages 107A, 107B, 107C, 107D is fixed in the prior art by differential pressure regulations, not illustrated in any more detail, in the multichamber locking labyrinth 100. The disadvantage of this is that, even in the event of atmospheric sealing off, a relatively large quantity of locking gas has to be supplied via a corresponding gas stream 113C. Furthermore, a relatively large quantity of process gas has to be supplied via a gas stream 113A, in order to achieve a corresponding locking action in the leakage streams 115A, 115B.

It was recognized, within the framework of the present novel concept, that the essential problem arises from the use of differential pressure regulations which function efficiently only in the case of relatively high differential pressures beyond 0.1 bar. Corresponding differential pressures Δp between a first chamber 111A and a second chamber 111B and between a third chamber 111C and a second chamber 111B are depicted in FIG. 1. Consequently, relatively large quantities of process gas and locking gas are lost via the gas stream 113B through the chamber 105B and its outlet 111B. Furthermore, in addition, a relatively large quantity of locking gas is lost via the gas stream 113D through the chamber 105D and its outlet 111D. According to the prior art, it is sometimes necessary for a large quantity of locking gas leakage stream 115D to be lost through the gas passage 107D from the chamber 105C to the chamber 105D. Higher sealing-off pressures may occur, in particular, when a disposal device is operating at higher pressures—a flare usually has an excess pressure of up to 3 bar with respect to the pressure level in the chambers 105A, 105B, 105C, 105D. In the case of higher sealing-off pressures, the process gas loss (process gas leakage stream 115B) and/or the locking gas requirement (gas stream 113C) due to the relatively high locking gas loss (locking gas leakage stream 115C, 115D) rise/rises.

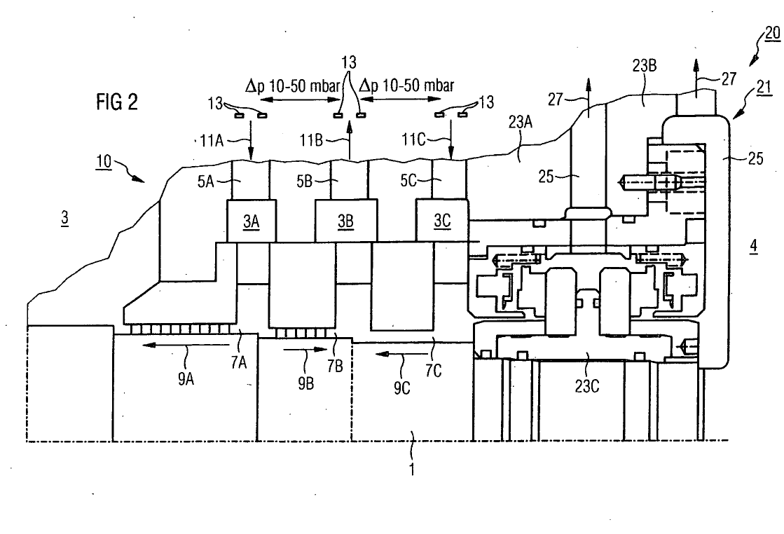

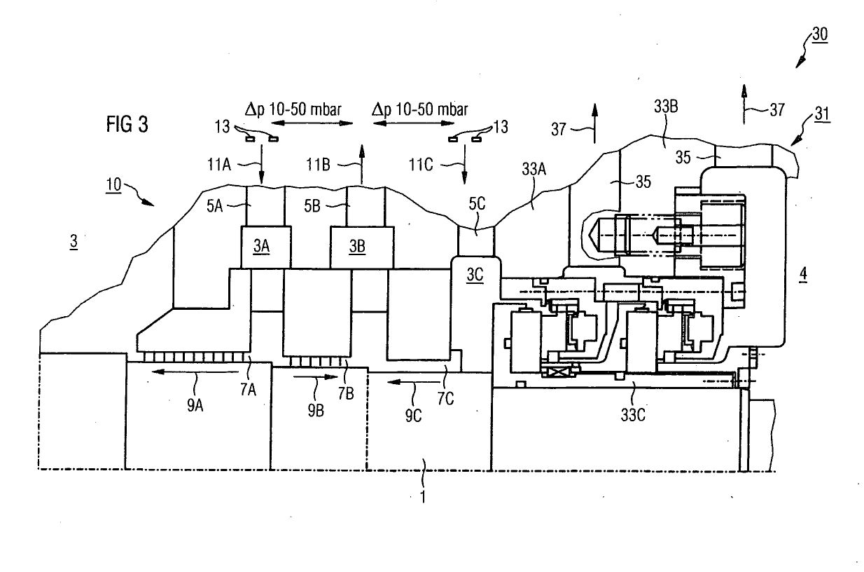

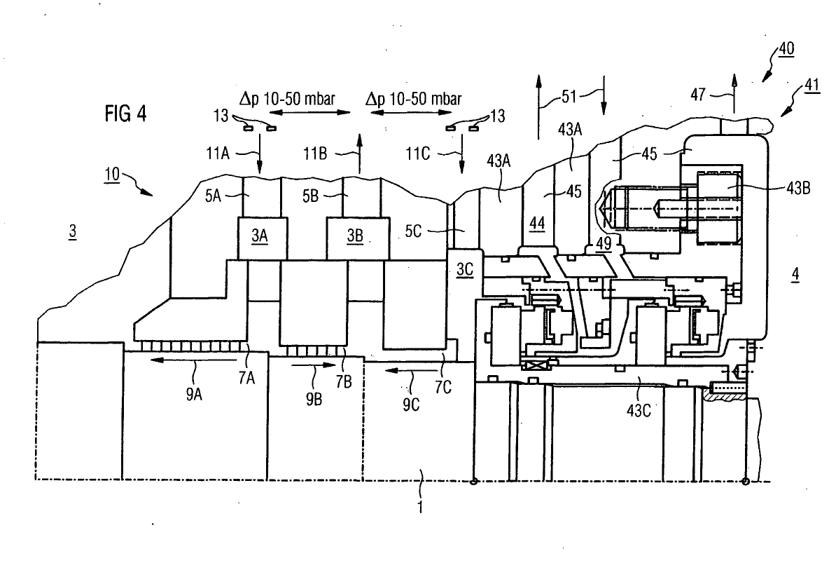

Such problems are avoided in the particularly preferred embodiments of a sealing system 20, 30, 40 according to FIG. 2, FIG. 3, and FIG. 4 by the use of a particularly preferred embodiment of a locking labyrinth 10. A sealing system 20, 30, 40 is formed with a double gas seal 21 in the case of FIG. 2 or with a tandem gas seal 31 with an internal labyrinth in the case of FIG. 3 or with a tandem gas seal 41 without an internal labyrinth. Moreover, in FIG. 2, FIG. 3 and FIG. 4, the shaft 1 of a compressor and also other features with a substantially identical function or design are given the same reference symbols.

In FIG. 2, FIG. 3 and FIG. 4, the locking labyrinth 10 in the form of a three-chamber locking labyrinth is formed from exactly three communicating chambers 3A, 3B, 3C. The first chamber 3A and the third chamber 3C have an inlet 5A and 5C. The second chamber 3B of the three communicating chambers has an outlet 5B. Moreover, the three communicating chambers 3A, 3B, 3C are connected via a gas passage 7A, 7B, 7C. In this case, the first gas passage 7A and the second gas passage 7B are designed for opposite gas leakage flows 9A, 9B. Furthermore, the gas passage 7C and 7B is designed for opposite gas leakage flows 9C and 9B. The third chamber 3C is designed to be acted upon with a locking gas in the form of a locking gas stream 11C. The first chamber 3A is designed to be acted upon with a process gas in the form of a process gas stream 11A.

The third chamber 3C has at its inlet 5C, not illustrated in any more detail, a quantity control element 13, not illustrated in any more detail, in the form of a diaphragm. This is designed for operation at a constant admission pressure for the locking gas of the locking gas stream 11C for acting upon the third chamber 5C at a predetermined throughput rate.

The third chamber 3C is therefore an inlet chamber. This gas seal-side inlet chamber, moreover, is outlet-free and has a gas passage 7C to the further communicating chamber 3B only. Moreover, the inlet chamber of the locking labyrinth 10 is arranged directly adjacently to the gas seal 21. In this case, the gas seal 21 and the locking labyrinth 10 are designed such that the gas seal 21 has a negligibly low gas leakage, as compared with the locking labyrinth 10. The inlet chamber is therefore delimited on its side facing away from the process gas space 3 by the gas seal 21, the gas seal 21 having a gas leakage lower by a multiple than the three-chamber locking labyrinth 10. Owing to this type of arrangement of a locking labyrinth 10 and of a gas seal 21 within the framework of a sealing system 20 of FIG. 2, the locking gas stream 11C is determined along its further run, and particularly with regard to its throughput rate, essentially by the gas passage 7C. That is to say, the quantity of locking gas fed in via the gas stream 11C will flow virtually at 100% through the locking labyrinth 10. This makes it possible, by means of a diaphragm 13 arranged at the inlet, not illustrated in any more detail, of the inlet chamber, to feed such a quantity of locking gas at a constant admission pressure into the inlet chamber via the locking gas stream 11C that, in the gas passage 7C, a locking gas leakage stream has a predetermined velocity which is sufficient for the reliable locking of the gas passage 7C with respect to process gas. This prevents process gas from reaching the gas seal 21.

So that the locking gas does not enter the process space, the second chamber 3B and the chamber 3A are arranged upstream of the third chamber 3C in the form of an inlet chamber. Process gas in the form of a process gas stream 11A is supplied by the chamber 3A to the chamber 3B through the gas passage 7B in the form of a process gas leakage stream 9B. The gas passage 7B is locked against locking gas due to the process gas locking flow 9b. A locking gas/process gas mixture 11b is discharged to the disposal via the chamber 3B and a quantity control element, not illustrated in any more detail, at the outlet 5B of the chamber 3B, in the form of a diaphragm. The disposal may be in the form of a flare, chlorine destruction or other purification, such as, for example, a water bath or a filter device.

The concept implemented within the framework of the particularly preferred embodiment of a locking labyrinth 10 results in a differential pressure Δp lower by a multiple, as compared with the prior art, in the present case in the range between 10 and 50 mbar, being established between the inlet chamber 3C and the second chamber 3B. This differential pressure is established solely via a quantity control device 13, not illustrated in any more detail, of the inlet chamber 3C and the second chamber 3B. In addition to the quantity control device 13, in this case it is critical, inter alia, that the third chamber 3C in the form of the inlet chamber of the locking labyrinth 10 is arranged directly adjacently to the gas seal 21 and that the gas seal 21 and the locking labyrinth 10 are designed in such a way that the gas seal 21 has a negligibly low gas leakage, as compared with the locking labyrinth.

So that the process gas loss is also minimized, the first chamber 3A is separated from the actual process gas space 13. In the present case, the process gas space 3 may be in the form of the actual compressor space on a suction side or delivery side of a compressor. A pressure in the first chamber 3A lies above the suction pressure in the process gas space 3. The pressure in the chamber 3A may, for example, be regulated constantly via the suction pressure of the process gas space. Irrespective of this, in this embodiment, the process gas flowing between the process gas space 3 and the first chamber 3A constitutes only an internally circulating gas quantity in the form of the process gas stream 11A, which neither has to be supplied from outside nor can be lost. A quantity control element 13 in the form of a diaphragm at the outlet 5B, not illustrated in any more detail, of the second chamber 3B is designed such that, at a given pressure in the first chamber 3A, the second chamber 3B allows only a predetermined quantity of process gas to pass out of the third chamber 3C in addition to the locking gas quantity supplied through the gas passage 7C via the locking gas leakage stream 9C. Thus, as compared with the prior art, an extremely low differential pressure Δp, which in the present case lies only in the range between 10 and 50 mbar, is also formed between the first chamber 3A and the second chamber 3B which is in the form of an outlet chamber. What is also ensured, furthermore, is that a process gas leakage stream 9B in the gas passage 7B is sufficient for locking the chamber 3A against locking gas, in order to prevent locking gas from entering the chamber 3A or the process gas space 3 and consequently the process gas stream 11A.

Typical velocities of the locking and process gas streams 11A, 11B, 11C for locking the gas sealing system 20, 30, 40, shown in FIG. 2, FIG. 3 and FIG. 4, which are operated via quantity control elements 13, lie at about 5-10 m/s. The gas seal leakage streams 9A, 9B, 9C lie in a range below 10% of these locking and process gas streams 11A, 11B, 11C. Gas seal leakages in the case of locking labyrinths operating with differential pressure regulation, such as that in FIG. 1, lie well above this. In previous differential pressure regulations, the velocities of locking gas streams or process gas streams likewise lie well above those of the preferred embodiments, to be precise at velocities of 50-80 m/s or more.

The gas seal illustrated in FIG. 2 is designed in the form of a double seal 21 which is formed essentially from two annular elements 23A, 23B seated on a webbed sleeve 23C and the shaft 1 and arranged mirror-symmetrically with respect to one another. The spaces between the annular elements 23A, 23B are ventilated by means of a ventilation system 25, with ventilation streams 27 being delivered to a vent, not illustrated.

The gas sealing system 30 of FIG. 3 is formed by the three-chamber locking labyrinth 10, already explained in connection with FIG. 2, and a tandem gas seal 31. The tandem gas seal 31 is in this case formed essentially by two annular elements 33A, 33B seated in the same orientation on a webbed sleeve 33C. The ventilation system 35 between the annular elements 33A, 33B is vented essentially by means of a ventilation flow 37 with access to a vent, not illustrated.

The particularly preferred embodiment of a sealing system 40, as illustrated in FIG. 4, is formed by the combination of a three-chamber locking labyrinth 10, as already explained in connection with FIG. 2, and a tandem gas seal with an internal labyrinth 41, the tandem gas seal 41 having an internal labyrinth to form a ventilation system 45. Otherwise, the tandem gas seal 41 is formed in a similar way to FIG. 3 by the arrangement of annular elements 43A, 43B oriented in the same direction on a webbed sleeve 43C. The interspaces between the two annular elements 43A, 43B are part of the ventilation system 45 and are vented by way of a vent via a ventilation flow 47.

It is thus possible, with the particularly preferred embodiments of a gas sealing system 20, 30, 40, as shown in FIG. 2, FIG. 3 and FIG. 4, using a locking labyrinth 10 according to the novel concept, to utilize the advantages of a gas seal, to be precise low leakage and reliable sealing off, even in the case of process gases which are not suitable for a gas seal, and even when no locking gas is to enter the process. Regulating the quantity of locking gas and, if appropriate, also of process gas via diaphragms 13 and admission pressure, particularly in the case of an inlet chamber 3C and an outlet chamber 3B, has the advantage that the throughput rate is markedly lower, as compared with differential pressure regulation of the prior art, since the differential pressures occurring in this case lie markedly below those which would have to be regulated reliably in the lower limit range by means of differential pressure regulation.

In summary, a concept for gas seals (21, 31, 41) has been presented. Gas seals are contactless seals for sealing off a process gas space (3) with respect to a leaktight space (4), a gas leakage, as a rule, being extremely low. Sometimes, process gases should not reach the gas seal (21, 31, 41), since they would damage this. This can be prevented by a locking labyrinth (10) with at least one chamber (3A, 3B, 3C) to be acted upon by a gas and to be arranged upstream of a gas seal (10). The problem, here, is the increasing leakage of process gas and/or locking gas which increases particularly with rising pressures. To overcome this problem, according to the invention, a chamber (3A, 3B, 3C) has a quantity control element (13) which is designed for operation at a constant admission pressure and for acting upon a chamber (3A, 3B, 3C) with a gas flow (11A, 11B, 11C) at a predetermined throughput rate. In contrast to conventional differential pressure regulation, a predetermined flow velocity, sufficient for reliable locking, is thus set in the locking labyrinth (10) in the case of an extremely low differential pressure (Δp). A gas leakage lower by a multiple, as compared with conventional locking labyrinths, is thereby achieved. For this purpose, in a gas sealing system (20, 30, 40), there is provision, according to the invention, for the locking labyrinth (10) to be arranged directly adjacently to the gas seal (21, 31, 41) and for the gas seal (21, 31, 41) and the locking labyrinth (10) to be designed in such a way that the gas seal (21, 31, 41) has a negligibly low gas leakage, as compared with the locking labyrinth (10).

1.-16. (canceled)

17. A sealing arrangement for sealing off a gap between a rotor and a housing in which process gas is located, comprising:
a double gas seal; and
a locking labyrinth arranged upstream of the double gas seal on a process gas side, where the locking labyrinth is acted upon by an acting gas, which locking labyrinth has a chamber with a quantity control element arranged in an inlet of the chamber for admitting the acting gas into the chamber at a constant admission pressure and for acting upon a chamber with a gas flow at a predetermined throughput rate.

18. The sealing arrangement as claimed in claim 17, wherein the sealing arrangement further comprises a plurality of communicating chambers, a first chamber having an inlet and a second chamber of the plurality of chambers having an outlet, and the chambers are connected by a gas passage, the inlet and/or outlet having a quantity control element designed for operation at a constant admission pressure and for acting upon a chamber with a gas flow at a predetermined throughput rate.

19. The sealing arrangement as claimed in claim 18, wherein the chamber is free of a differential pressure regulator.

20. The sealing arrangement as claimed in claim 19, wherein a double gas seal-side chamber is outlet-free with the exception of one or more gas passages only to a further space or a further chamber.

21. The sealing arrangement as claimed in claim 20, wherein a differential pressure between the chamber and the further space and/or between two communicating chambers during operation lies below 100 mbar.

22. The sealing arrangement as claimed in claim 21, wherein a differential pressure between the chamber and the further space and/or between two communicating chambers during operation lies below 50 mbar.

23. The sealing arrangement as claimed in claim 22, wherein the quantity control element is a diaphragm.

24. The sealing arrangement as claimed in claim 23, wherein the quantity control element is regulatable.

25. The sealing arrangement as claimed in claim 24, wherein the sealing arrangement comprises three communicating chambers, a first and a third of the three chambers having an inlet and a second of the three chambers having an outlet and the three communicating chambers are connected via at least one gas passage.

26. The sealing arrangement as claimed in claim 25, wherein the second chamber is arranged between the first and the third chamber, and a first gas passage is formed between the first and the second chamber and a second gas passage between the third and the second chamber, where the first and the second gas passage are constructed and arranged for opposite gas flows.

27. The sealing arrangement as claimed in claim 26, wherein the first chamber is constructed and arranged for a process gas to act upon the first chamber and the third chamber is constructed and arranged for a locking gas to act upon third chamber.

28. The sealing arrangement as claimed in claim 27, wherein
an inlet chamber of the locking labyrinth is arranged directly adjacently to the double gas seal, and
the double gas seal and the locking labyrinth are designed such that the double gas seal has a low gas leakage relative the locking labyrinth.

29. The sealing arrangement as claimed in claim 28, wherein the gas leakage of the double gas seal is less then ten times the gas leakage of the locking labyrinth.

30. A compressor, comprising:
a rotatable compressor shaft;
a double gas seal; and
a locking labyrinth arranged upstream of the double gas seal on a process gas side, where the locking labyrinth is acted upon by an acting gas, which locking labyrinth has a chamber with a quantity control element arranged in an inlet of the chamber for admitting the acting gas into the chamber at a constant admission pressure and for acting upon a chamber with a gas flow at a predetermined throughput rate.

31. A method for sealing off a process gas space with respect to a leaktight space, with a gas sealing system having a double gas seal and a locking labyrinth arranged upstream of the double gas seal on the process gas side and having at least one chamber, comprising:
arranging an inlet chamber directly adjacently to the double gas seal double gas seal;
acting upon the locking labyrinth with a gas;
keeping a gas leakage of the double gas seal low, as relative to a gas leakage of the locking labyrinth; and
acting upon a chamber with a constant admission pressure and with a gas flow at a predetermined throughput rate where the gas flow is quantity-regulated.
